(19) United States
(12) Patent Application Publication
(10) Pub. No.: US 2012/0218896 A1
(43) Pub. Date: Aug. 30, 2012

(54) CENTRALIZED SUPERVISION OF NETWORK TRAFFIC

(75) Inventors: Peter Ygberg, Stockholm (SE); Per-Olof Jacobsson, Lidingo (SE)

(73) Assignee: SAAB AB, Linkoeping (SE)

(21) Appl. No.: 13/505,963

(22) PCT Filed: Nov. 4, 2009
(86) PCT No.: PCT/SE09/51248

§ 371 Date: May 3, 2012

(51) Int. Cl. H04L 12/24; H04L 12/56

(52) U.S. Cl. 370/235

(57) ABSTRACT

A method and a device for supervising a computer network node in a computer network. The method includes receiving a network packet on a node input port, analyzing the received network packet, configuring a filter based on the analysis, sending the network packet to a filter input on the filter, and sending the filter output on the filter on the node output port.

### TECHNICAL FIELD

The present invention relates to data communication networks and, more particularly, to the supervision and traffic management of such networks. The invention especially targets centralized supervision of data communication network nodes, operating in a safety critical communication network with a known network traffic pattern.

### BACKGROUND

The data communication network is nowadays a key component in electronic systems implemented in vehicles ranging from submersibles to aircrafts. Many of these vehicles are depending on fault tolerant and secure communication networks to be able to operate in a reliable and safe manner. However, modern communication networks are highly vulnerable to faulty network traffic, which for example may arise from everything from failing network equipment to an attack on the network by a hostile party. If a communication network is subjected to faulty network traffic it may be severely impaired or even break down, resulting in denial of service which in most cases will cripple the vehicle. Thus finding a way to manage faulty network traffic in a communication network is therefore highly sought for.

### SUMMARY OF THE INVENTION

With the above description in mind, then, an aspect of the present invention is to provide a way to safeguard a data communication network from being affected by, or even break down from, faulty network traffic.

As will be described in more detail by the aspects of the present invention below, one way to provide such a safeguard is to provide centralized supervision of the data communication network nodes in combination with using a known network traffic pattern when communicating in the network.

A first aspect of the present invention relates to a method for supervising a computer network node in a computer network, comprising the steps of receiving a network packet on a node input port, analyzing said received network packet, configuring a filter based on said analysis, sending said network packet to an filter input on said filter, and sending the filter output on said filter on the node output port.

The method may further comprise the step of classifying said received network packet.

The method wherein the network packet in said analysis step may further be analyzed in view of statistic parameters.

The method wherein said statistic parameters may further be based on parameters of received network packets on said node input.

The method wherein said statistic parameters may further be based on predefined traffic pattern of received network packets.

The method wherein the network packet in said analysis step may further be analyzed in view of predefined parameters.

The method wherein said analysis may further be based on a known network traffic pattern.

The method wherein said network packet in said analysis step may further be analyzed in view of said packets classification.

The method wherein the step of configuration the filter may further comprise the step of setting the filter to either forward or drop the network packet.

The method wherein the step of configuration the filter may further comprise the step of setting the filter to give priority to the network packet.

The method wherein the step of configuration the filter may further comprise the step of setting the filter to give priority according to said classification of said network packet.

The method wherein the step of configuration of the filter may further comprise the step of configuring said node input port to either drop or receive network packets following said received packet on said node input port.

The method wherein the step of configuration of the filter may further comprise the step of configuring said node output port to either drop or send network packets following said received packet on said node output port.

The method wherein said reception and said sending of said network packets may further be performed using a predefined traffic pattern.

A second aspect of the present invention relates to a device for supervising a computer network, comprising a reception unit for receiving a network packet on a device input port, a filter unit comprising, a filter, an analyzing unit for analyzing said received network packet, a supervisor unit capable of configuring the filter for filtering received network packet based on said analysis in said analyzing unit, and a sending unit for sending the output from said filter unit on the device output port.

The device may further comprise a classification unit for classifying said received network packet.

The device may further comprise a statistics collector unit in said filter unit.

Any of the features in the first and second aspect of the present invention above may be combined in any way possible.

### BRIEF DESCRIPTION OF THE DRAWINGS

Further objects, features, and advantages of the present invention will appear from the following detailed description of some embodiments of the invention, wherein some embodiments of the invention will be described in more detail with reference to the accompanying drawings, in which:

FIG. 1 shows a typical data communication network with interconnected nodes; and

FIG. 2 shows an example of a basic approach to safety critical network switching using bandwidth shaping and statistical supervision; and

FIG. 3 shows an example of a centralized approach to safety critical network switching according to an embodiment of the invention; and

FIG. 4 shows an example of an FPGA implementation of a centralized approach to safety critical network switching according to an embodiment of the invention.

### DETAILED DESCRIPTION

Embodiments of the present invention will be described more fully hereinafter with reference to the accompanying drawings, in which embodiments of the invention are shown. The invention may, however, be embodied in many different forms and should not be construed as limited to the embodiments set forth herein. Rather, these embodiments are provided so that the disclosure will be thorough and complete, and will fully convey the scope of the invention to those skilled in the art. Like reference signs refer to like elements throughout.

The present invention will be exemplified using the well known frame-based computer network technology for local area networks (LANs) known as Ethernet. Ethernet has been defined by the Institute of Electrical and Electronics Engineers (IEEE) in standard 802 (current revision is 802.3). However, it should be noted that the present invention may also be applied to, and implemented in, any data communication network utilizing a known network traffic pattern.

A known traffic pattern may be achieved in a network where all nodes in the network act according to a predefined agreement which stipulates when, how, and to what extent the network traffic, i.e. packets, may flow between the nodes in the network. In this way an organised and deterministic traffic flow between the nodes in the network may be achieved.

A network node, or just node, may either be a connection point, a redistribution point, or an end point in a communication network. A physical network node is an active electronic device belonging either to the group of data circuit-terminating equipment (i.e. a modem, hub, bridge, switch, etc.) or to the group data terminal equipment (such as a modem, hub, bridge, switch, router, printer, host computer, server, a network storage unit, etc.).

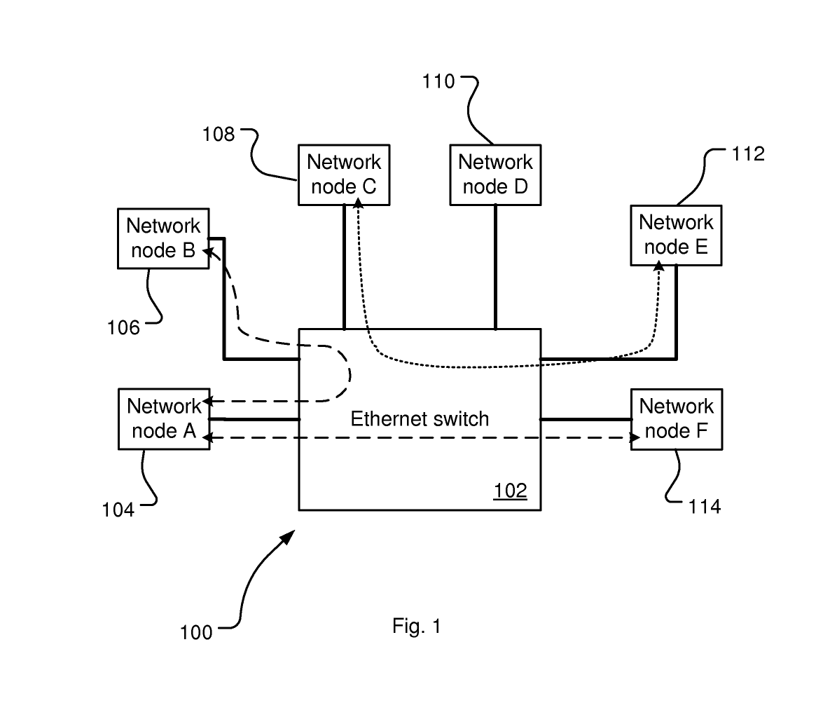

FIG. 1 illustrates a typical data communication network 100 comprising an Ethernet switch 102 connected to a collection of network nodes denoted ‘Network node A’ 104 to ‘Network node F’ 114. In this example all network nodes 104-114 are capable of communicating with each other via the Ethernet switch 102. In an example, some nodes in the network might communicate in strict pairs as is illustrated by the dotted line between nodes C 108 and E 112, while other nodes might communicate with each other sharing the same destination node, as illustrated by the dashed lines in the figure where node A 104 is shared as the destination node by both node B 106 and node F 114. In this example shown in FIG. 1 the traffic between the nodes might be served in a First-In-First-Out manner, for instance packets coming from node B 106 destined to node A 104 might become queued in the Ethernet switch 102 if a packet from node F 114 already is in transit to node A 104. When such queuing occurs, a latency is added to the total transfer time of the packets between the nodes, which in some cases may lead to problems such as less accuracy in a time critical application. However, if all nodes in the network would comply with a predefined traffic pattern it would become possible to ensure that no queuing would occur in the Ethernet switch 102, and thus no additional latencies would be induced in the network.

In the same manner, if one of the network nodes 104-114 in FIG. 1 would fail, due to malfunction or due to an attack by a hostile party, it may literally flood the network with faulty traffic. The faulty traffic may then generate long queues in the switch 102, which will have a negative effect on the transfer time in the network. In worst case scenario the congestion of the switch 102 might lead to an overload resulting in packet loss or even a complete breakdown of the communication in the network (denial of service). For example if node C 108 fails and begins to send out packets to all other nodes in the network it will congest the Ethernet switch 102, resulting in that valid packets coming from node B 106 going to node A 104 will be delayed or even dropped in the switch. Avoiding such scenarios as described in above examples where faulty network traffic disrupts or even bring down a communication network is especially important in safety critical communication networks.

In safety critical communication networks, used for instance in avionics, it is as discussed above crucial to ensure that each network node is behaving correctly, for example complying with an agreed traffic pattern, and is not interfering with the communication of other nodes in the network. Ensuring the correct behaviour of the network nodes in a network may be achieved in several different ways depending on the level of required safety needed. However, often the safety aspects imply certain performance limitations in terms of bandwidth and/or latency impact on the communication between nodes. One approach is to ensure that network traffic between the nodes never collides, and thus never need to be queued in the network switch, by introducing a communication scheme (or protocol) based on time slots such as utilized by the Real Time High Integrity network (RTHI) protocol.

Each node in a network employing the RTHI protocol, hereinafter referred to as a RTHI node, is assigned a certain time slot in which it is allowed to transmit. The receiver part of a node will monitor the incoming traffic to ensure that each received packet arrives in a correct timeslot. If a packet is received outside the correct timeslot, the receiving RTHI node may instruct the network switch to shut down the input port connected to the node that transmits packets outside the correct timeslot by sending a “babble cut-off message” to the network switch. If a node enters a faulty state it may, depending on what faulty traffic the node starts to send, introduce a network overload which, as discussed above, could result in dropped packets within the network switch. In an ordinary Ethernet network switch it is difficult to ensure that certain packet types, for example control messages or packets belonging to valid traffic, are not part of the packets that might get dropped in such an overload scenario. Thus finding a way to manage faulty network traffic in a communication network, and especially in a safety critical communication network, is therefore highly sought for.

To remedy the deficiencies discussed above, and especially when switching safety critical traffic in a communication network, such as a communication network used in avionics, there are at least two different approaches that can be applied. Either the network switch is kept basic, leaving no or limited supervision capabilities in the network nodes, or the network switch is put to use for implementing a centralized supervision of the network at the same time as performing its normal functionality.

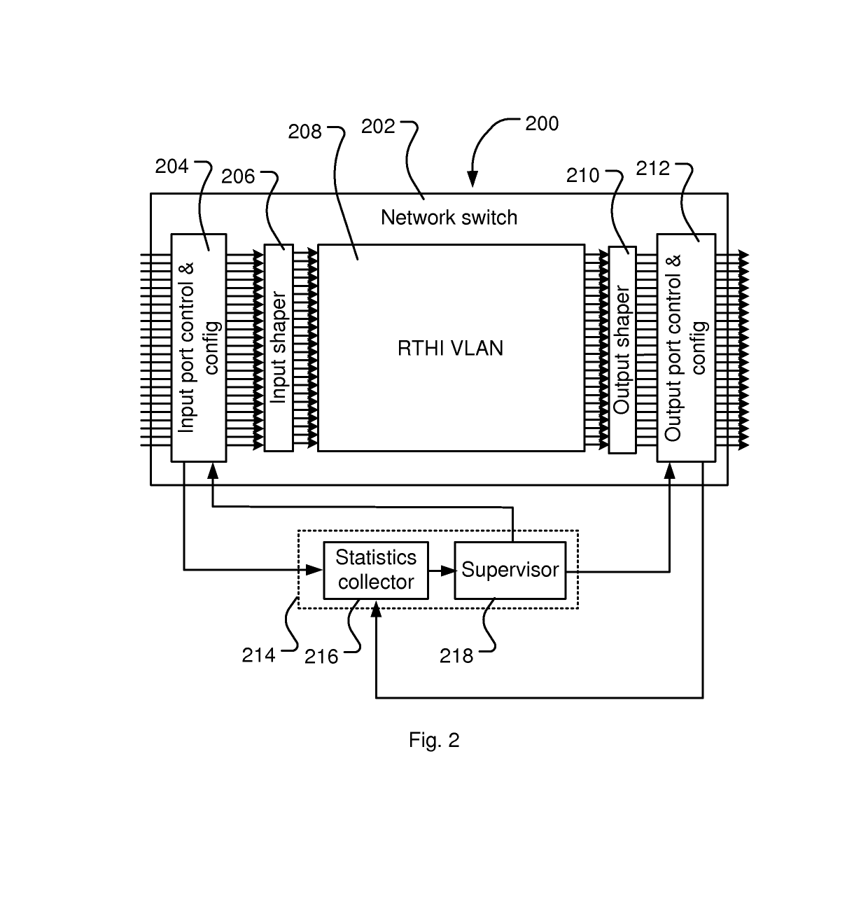

One way of implementing a safety critical network switch is to utilize some limited actions that can be applied within the common Ethernet network switch, namely bandwidth shaping and statistics supervision. FIG. 2 illustrates an embodiment of such a basic approach to safety critical network switching 200 using bandwidth shaping and statistical supervision. The packets are received on the input port 204 of the switch 202, which in this example is an Ethernet network switch. Input statistic 216 are collected and updated for each packet received on the input port 204 of the network switch 202. The statistics 216 may include parameters such as the number of received packets, total number bytes received, as well as a breakdown of how many packets has been received within certain packet size intervals. The statistic parameters may also include the number of erroneously received packets such as CRC-faulty and runt packets. In one variant of the invention the input statistics 216 may be used to monitor the traffic pattern for each input port 204, and compare the collected statistics with what would be expected based on a predefined bandwidth and traffic pattern port usage.

The received packets on the input port 204 may in one variant of the present invention be subjected to classification. The input classifier may assign each received packet a traffic class based on incoming port and/or on other parameters such as user priority and VLAN identification (VID). In this a classifier may be used to identify certain traffic that should always be handled with for instance a higher priority compared to any other traffic. This could for example be used to prioritize forwarding of time synchronization messages within an Ethernet network.

After the reception and classification of incoming packets, so called input shaping 206 may be applied to the packets. An input shaper primarily measures the bandwidth of incoming traffic on a particular input port, or within a defined traffic class. In this way input shaping 206 provides a mean for bandwidth shaping, i.e. ensuring that traffic above a certain defined bandwidth limit are blocked or discarded. The input shaper may in this way be used as a security mechanism to prevent a faulty network node to inject packets above a predefined threshold bandwidth limit. The traffic classification performed in the input port 204 may be used as an additional criterion during shaping and forwarding decisions further into the switch.

After shaping 206, the packets proceed to the input of the RTHI VLAN. The RTHI VLAN is an ordinary VLAN deploying the RTHI protocol, resulting in a secure time slot based Ethernet communication network. The synchronous Ethernet based communication of RTHI provides a mechanism to synchronize time in a safety critical communication system, such as an avionics system, as well as providing a platform for synchronous communication between Ethernet connected nodes. The RTHI end node requirements do not impose extra requirements on the Ethernet network switch 200 compared to what is expected from a standard IEEE802.1 Ethernet network switch. It is basically a question of being able to switch packets back-to-back with a minimum delay. The packets exiting the RTHI VLAN is forwarded to the optional output shaper 210.

In the optional output shaper 210 a decision to drop the packet based on bandwidth usage can be made. In the output shaper 210 the bandwidth usage on each output port is measured and each port is assigned an individual maximum allowable bandwidth, and if the output traffic on the output shaper 210 exceeds the configured bandwidth limit the packet may be dropped. The output shaping 210 may in this way be used to ensure that the bandwidth directed to an externally connected device such as another switch or node, never exceed the bandwidth the receiver supports (for example if only a well known bandwidth of non-safety critical traffic is allowed to be sent out on a specific port). In this way the switch may not be congested as discussed above.

Before the packets exits the switch they are passed through the output ports 212 where the port forwarding state is examined. If the forwarding state is not set to FORWARDING the packet is dropped, otherwise it is sent out on the output port 212.

In the same manner as the input port 204, output statistics 216 may be collected on the output port 212. Output statistic 216 may be collected and updated for each packet sent out from the network switch 202, and the statistics 216 may include parameters such as how many packets of certain sizes has been sent, what the total number bytes transmitted is, how many transmission errors has occurred, and so on. The output statistics may be used to monitor the traffic flowing out of each output port 212 and in this way enable detection of misbehaving traffic patterns. The statistics may be collected and treated in several different ways. One way is to continuously make use of all collected data while another way is to average the collected data over a period of time. The statistics produced in these two different ways disclose different information regarding the traffic condition in the network. In one variant of the invention the statistics may be based on both continuous and averaged data, while in another variant of the invention the statistics may be based on either continuous data or averaged data.

The statistics collector 216 and supervisor 218 units may, as shown in FIG. 2, be implemented separate 214, in a centralized manner, from the network switch 202. The supervisor 218 continuously and/or at given time instants receives statistical traffic information, collected from the input and output ports 204,212 by the statistics collector 216. The supervisor 218 decides, based on the collected statistics, if the input port and/or the output port should be closed, stopping all incoming and/or outgoing traffic from reaching and/or leaving the network switch. Faulty traffic may initially pass through the switch due to the fact that the supervisor needs sufficient statistics from the statistics collector to make a correct decision regarding shutting down the input/output ports or both.

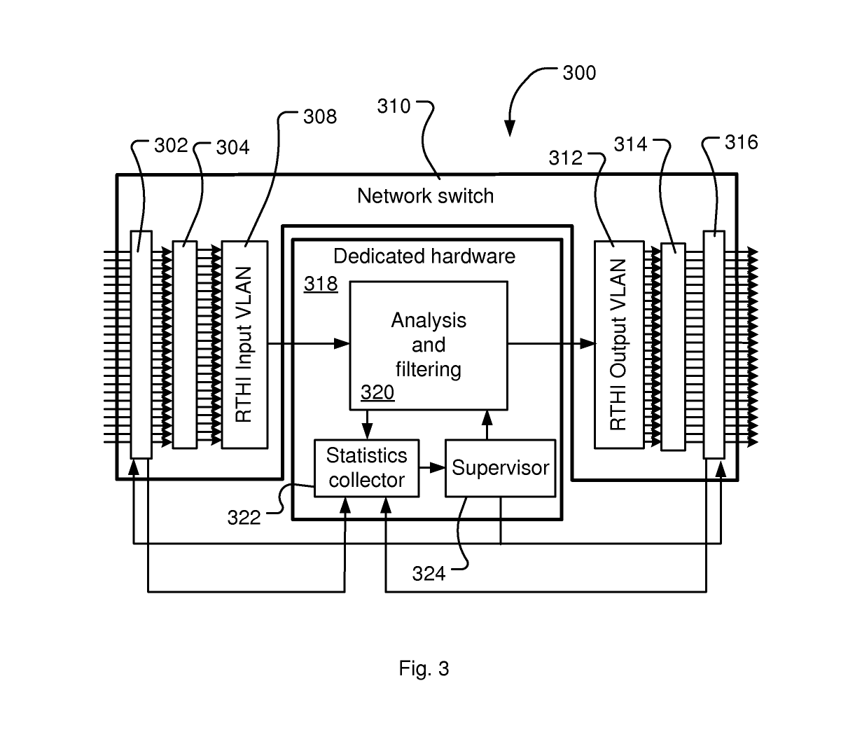

However, to be able to detect faulty traffic at a much earlier stage, and to be able to discard faulty traffic before it affects other network nodes in the network, the centralized monitoring and supervising functionality must be inserted into the actual dataflow. The application of centralized monitoring and supervising functionality enables inspection, followed by an applicable action, for each packet sent from a network node through the switch on its way to its destination node. To implement such functionality one could implement the complete network switch together with the supervisor functionality in dedicated hardware such as an FPGA or an ASIC. However, this would become a quite complex and costly design, including not only most of the IEEE802.1 standard switch features found in an Ethernet switch but also the added supervision functionality. A more cost efficient approach would be, as suggested in the embodiment of the present invention shown in FIG. 3, to make use of existing Ethernet network switch components and combine these with the required additional centralized monitoring and supervision functionality. FIG. 3 shows an example, using functional blocks, how an Ethernet switch with integrated centralized monitoring and supervision 300 may be implemented.

In the embodiment of the present invention shown in FIG. 3, a dedicated hardware block 318, comprising the centralized monitoring and supervision functionality, has been connected to the network switch 310.

Packets arriving to the network switch 310 may, in the same manner as described in conjunction with FIG. 2, be received and classified in the input port 302. Statistical information is collected by the statistics collector 322 which, in the same manner as described above, be used by the supervisor 324 to either block or forward the packets received on the input port 302. In this embodiment, both the statistics collector 322 and the supervisor 324 is implemented in the dedicated hardware 318 connected to the network switch 310. After a packet is received at the input port 302 it may be forwarded to the input shaper 304 implemented in the network switch 310.

As discussed in conjunction with FIG. 2, the input shaper 304 of the network switch 310 enables configuration of the maximum allowed input bandwidth on a per input port basis. If the incoming packet traffic coming from the input port 302 is within an allowed bandwidth limit the packets are forwarded further into the switch, if not the packets are blocked.

Following the input shaper 304 the incoming packet traffic would be assigned an input VLAN ID in the RTHI input VLAN block 308, which is different from the output VLAN ID assigned in the RTHI output VLAN block. In this way packet traffic is prevented to flow directly from an input port 302 to an output port 316 without first passing the dedicated hardware 318. Based on the configured forwarding rules of the RTHI input VLAN 308, each received packet is sent to the dedicated hardware 318. In the dedicated hardware unit 318, the destination and source address is looked up, in the analysis and filtering unit 320, to verify that communication between these two addresses is allowed during the current timeslot, and if this is the case, and no other action is to be taken, the packet is sent out of the dedicated hardware unit 318 back into the network switch via the RTHI output VLAN block 312. If not, the packet may be dropped. When a faulty packet is detected and dropped it is also possible to decide not to accept any more packets from the input port 302 on which the packet was received on. The input port 302 may in this way be set in a blocking mode, i.e. not accepting any more packets from that particular input port.

The correct and thus allowable packets are sent back into the network switch via the RTHI output VLAN 312 where they may be subjected to optional shaping in the output shaper 314. The output shaper 314 can, in the same manner as described in conjunction with FIG. 2, make a decision whether to drop packets, or not, based on the bandwidth usage. The bandwidth usage on each output port is measured and each port may be assigned an individual maximum allowable bandwidth, and if the output traffic on the port exceeds the configured bandwidth limit the packet may be dropped. The output shaper function 314 is not necessary to the invention, and may in one variant of the present invention be omitted, and in another variant be included.

Before the packets exits the switch they are passed through the output ports 316 where the port forwarding state is examined. If the forwarding state is not set to FORWARDING the packet may be dropped, otherwise it is sent out on the output port 316.

In this embodiment traffic statistics are not only collected by the statistics collector 322 from the input and output ports 302, 316, which was the case in the embodiment described in conjunction with FIG. 2, but also from the analysis and filtering unit 320 in the dedicated hardware unit 318. In this way traffic statistics is collected both before, in the input port 302, and after, in the dedicated hardware unit 318, the input shaper 304, and the difference in statistics may for instance show how many packets that have been dropped in the input shaper. Packet drop in the input shaper 304 may be an indication of a current or emerging bandwidth problem. In this way the supervisor 324 may take appropriate measures based on the statistics from the input port 302 and the analysis and filtering unit 320. The statistics collected from the analysis and filtering unit 320 may also indicate the drop rate of faulty packets in the analysis and filtering unit 320 coming from the verification of destination and source addresses of the received packets as discussed in conjunction with FIG. 2 above, and take action based on that knowledge. All collected statistics coming from the input port 302, output port 316, and the analysis and filtering unit 320 is provided to the supervisor 324 in the dedicated hardware block 318. The supervisor 324 then acts on the received statistics from the statistics collector 322 and depending on its decision regulates or controls the input port, output port, and/or the analysis and filtering function in such way that faulty network traffic may be managed. In this way a safety critical communication network capable of manage faulty network traffic may be achieved.

The analysis and filtering unit 320, the supervisor 324, and the statistics collector 322, which are the main functional parts of the dedicated hardware unit 318, may be viewed as a an advanced filtering unit capable of filtering the network packet traffic passing through the network switch 310.

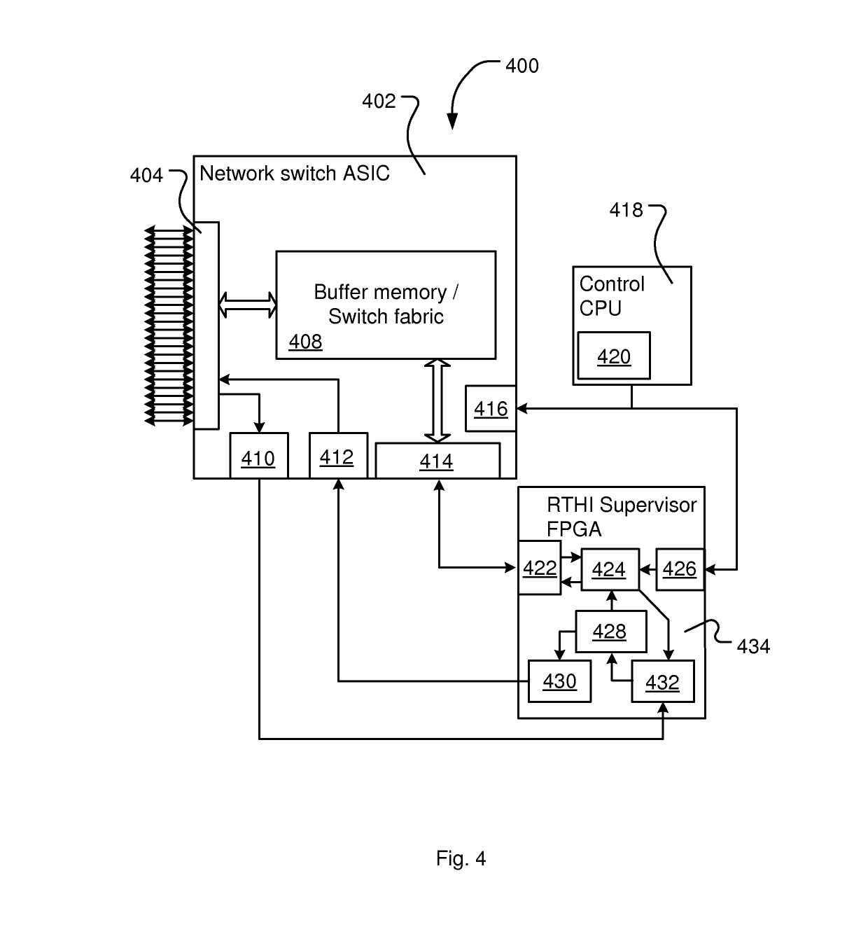

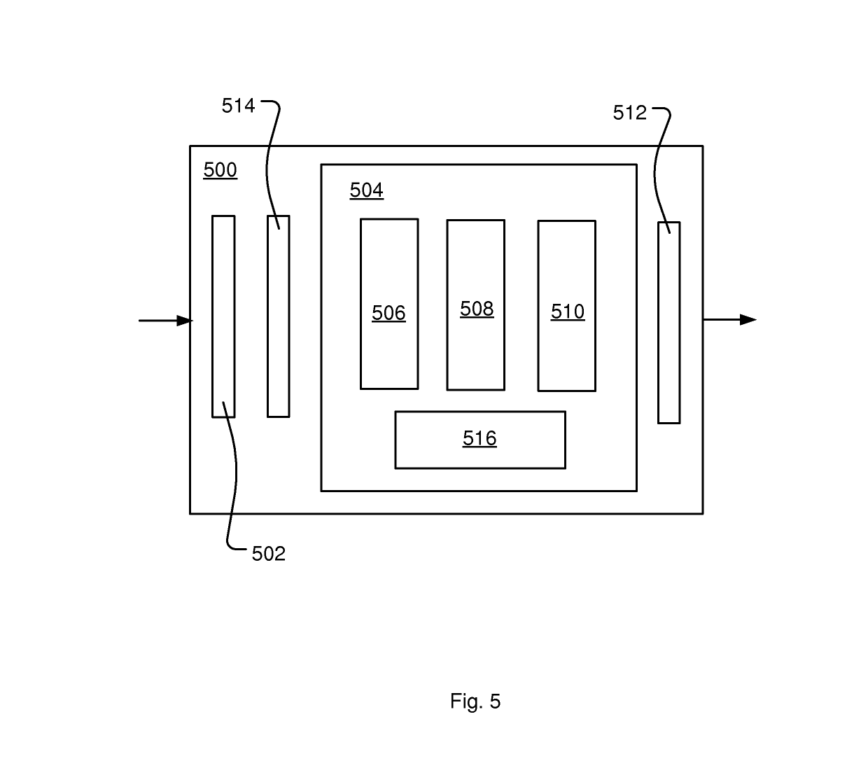

FIG. 4 shows an example of a hardware implementation of the centralized supervision approach to safety critical network switching 400 discussed in conjunction with FIG. 3. In FIG. 4 a common off-the-shelf Ethernet network switch ASIC 402 has been connected to a dedicated hardware unit, which in this case is an FPGA, running an implementation of the RTHI based supervision function. The network traffic consisting of packets is received at the combined input/output port 404 on the network switch 402. Statistical data of the received packets is collected on the input port 404 by standardized RMON counters 410, and transmitted to the statistics collector 432 in the RTHI Supervisor FPGA 434. The received packets on the input port 404 are forwarded to the buffer memory/switch fabric 408 where they may be subjected to classification and shaping according to the description in conjunction with FIG. 3. The packets are forwarded from the buffer memory/switch fabric 408, via two high speed input/output ports 414, in the network switch to corresponding input/output ports 422 on the RTHI supervisor FPGA 434. The arriving packets from the network switch 402 are sent to the analysis and filtering unit 424, controlled by the supervisor 428. In the analysis and filtering unit 424 the destination and source address of each packet is looked up to verify that communication between these two addresses is allowed during the current timeslot. The supervisor 428 make the decision whether to drop or discard (i.e. filtering the packets) a packet based on the analysis of the addresses and/or on the statistics provided by the statistics collector 432. The analyzed and filtered 424 packets are then sent back, via the two input/output ports 422, 414, to the network switch 402. The arriving packets on the input/output port 414 of the network switch 402 are then forwarded to the buffer/switch fabric 408 where they, before they are sent back out via the combined input/output port 404 onto the network, may be subjected to optional output shaping as described in conjunction with FIG. 3. The supervisor 428 is capable of controlling functionality of the combined input/output port 404 via a port control 430 on the RTHI supervisor FPGA 434 and a port configurator 412 in the network switch 402. The control CPU 418 comprise of a control unit 420, which is used for synchronization and management of the communication between the network switch 402 and the RTHI supervisor FPGA 434. The control CPU 418, which may either be integrated into the RTHI supervisor FPGA or implemented as stand-alone hardware (as in the example in FIG. 4), is connected to the network switch ASIC and to the RTHI supervisor FPGA 434 via the control inputs 416, 426.

In the way, as described above, a complete control of the traffic flowing through the network switch, and the functionality of the network switch itself, can be maintained, thus mitigating or even eliminating the problems arising from faulty network traffic discussed above. An advantage of the present invention is that it may, as shown in FIG. 4, be implemented using standard off-the-shelf hardware components, thus making it very cost effective.

FIG. 5 shows a schematic view, in the form of a block diagram, of the present invention as described in conjunction with FIGS. 3 and 4 above. The figure shows a device 500, typically a computer network node, for supervising a computer network comprising a reception unit 502 for receiving a network packet on a device input port, a filter unit 504 comprising, a filter 508, an analyzing unit 506 for analyzing said received network packet, a supervisor unit 510 capable of configuring the filter 508 for filtering received network packet based on said analysis in said analyzing unit 506, and a sending unit 512 for sending the output from said filter unit on the device output port. The device 500 may also include a classification unit 514 for classifying said received network packet received on the device input port. Also the filter unit 504 may include a statistics collector unit 516 capable of extracting statistical data (as discussed in conjunction with FIGS. 2-4 above) from for instance the reception unit 502 and the analyzing unit 506, and capable of providing the supervisor with statistical data. The filter unit 504 may either be integrated into the device 500 or be implemented as an external unit connected to the device 500 via an interface.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A method for supervising a computer network node in a computer network, the method comprising:
introducing a communication scheme based on time slots;
receiving a network packet on a node input port;
analyzing said received network packet;
configuring a filter based on said analysis;
sending said network packet to a filter input on said filter;
sending the filter output on said filter on the node output port;
looking up destination and source address;
verifying that communication is allowed between destination and source address during current time slot; and
if not allowed, the packet may be dropped.

2. The method according to claim 1, further comprising:
classifying said received network packet.

3. The method according to claim 1, wherein the network packet in said analysis step is analyzed in view of statistical parameters.

4. The method according to claim 3, wherein said statistical parameters are based on parameters of received network packets on said node input.

5. The method according to claim 3, wherein said statistical parameters are based on a predefined traffic pattern of received network packets.

6. The method according to claim 1, wherein the network packet in said analysis is analyzed in view of predefined parameters.

7. The method according to claim 1, wherein said analysis is based on a known network traffic pattern.

8. The method according to claim 2, wherein said network packet in said analysis is analyzed in view of said packets classification.

9. The method according to claim 1, wherein the configuration of the filter comprises setting the filter to either forward or drop the network packet.

10. The method according to claim 1, wherein the configuration of the filter comprises setting the filter to give priority to the network packet.

11. The method according to claim 2, wherein the configuration of the filter comprises setting the filter to give priority according to said classification of said network packet.

12. The method according to claim 1, wherein the configuration of the filter further comprises configuring said node input port to either drop or receive network packets following said received packet on said node input port.

13. The method according to claim 1, wherein the configuration of the filter further comprises configuring said node output port to either drop or send network packets following said received packet on said node output port.

14. The method according to claim 1, wherein said reception and said sending of said network packets is performed using a predefined traffic pattern.

15. A device for supervising a computer network, the device comprising:
a reception unit configured to receive a network packet on a device input port;
a filter unit comprising, a filter, an analyzing unit configured to analyze said received network packet, a supervisor unit capable of configuring the filter to filter the received network packet based on said analysis in said analyzing unit; and
a sending unit configured to send the output from said filter unit on the device output port.

16. The device according to claim 15, further comprising:
a classification unit configured to classify said received network packet.

17. The device according to claim 15, wherein said filter unit further comprises a statistics collector unit.
